(19) United States
(12) Patent Application Publication
(10) Pub. No.: US 2014/0229228 A1
(43) Pub. Date: Aug. 14, 2014

(54) DETERMINING RISK ASSOCIATED WITH A DETERMINED LABOR TYPE FOR CANDIDATE PERSONNEL

(71) Applicants: Deborah Ann Rose, Corvallis, OR (US); Bridgit J. LaBelle, Corvallis, OR (US); Paula Petersen, Roseville, CA (US); Sharon Webb, Auburn, CA (US); Nathalie Dhenin Bucion, Sainte-Agnes (FR); Jennifer Rogers, Redwood City, CA (US); Dan Kirk, Rocklin, CA (US)

(72) Inventors: Deborah Ann Rose, Corvallis, OR (US); Bridgit J. LaBelle, Corvallis, OR (US); Paula Petersen, Roseville, CA (US); Sharon Webb, Auburn, CA (US); Nathalie Dhenin Bucion, Sainte-Agnes (FR); Jennifer Rogers, Redwood City, CA (US); Dan Kirk, Rocklin, CA (US)

(21) Appl. No.: 14/239,866

(22) PCT Filed: Sep. 14, 2011
(86) PCT No.: PCT/US2011/051487

§ 371 Date: Feb. 20, 2014

(51) Int. Cl. G06Q 10/06

(52) U.S. Cl. CPC G06Q 10/0635
USPC 705/7.28

(57) ABSTRACT

Information relating to candidate personnel to be engaged by an enterprise is received. A risk associated with a determined labor type for the candidate personnel is determined.

### BACKGROUND

An enterprise (e.g. company, educational organization, government agency, an individual, etc.) can engage personnel to perform services on behalf of the enterprise. There can be various different types of personnel, including employees, contractors, or other types of personnel.

### BRIEF DESCRIPTION OF THE DRAWINGS

Some implementations are described with respect to the following figures:

FIG. 1 is a block diagram of an example system incorporating some implementations;

FIG. 2 is a flow diagram of a process according to some implementations;

FIGS. 3A-6 are flow diagrams of processes according to additional or alternative implementations.

### DETAILED DESCRIPTION

It can be difficult for an enterprise (e.g., an entity such as a business, educational organization, government agency, individual, etc. that is able to engage services of personnel) to correctly classify a contingent labor type of personnel engaged by the enterprise. Examples of contingent labor types include an agency contractor, a consultant contractor, an outsourced services contractor, a freelancer, and so forth. More generally, contingent labor refers to a worker used for assistance with special projects, on a temporary basis, to provide a workforce buffer for business fluctuations, or provide outsourced expertise. Contingent labor differs from an employee, which refers to personnel hired by an enterprise and paid on a regular basis by the enterprise. A freelancer refers to a self-employed individual, or an entity (separate from the enterprise) that employs three (or some other predefined number) or less employees. An agency contractor refers to a temporary worker that is employed through an agency and is given an assignment at the enterprise, where the enterprise manages the day-to-day work of the worker.

A consultant contractor refers to a worker or workers who provide unique and/or specialized expertise that are advisory in nature. An engagement of the consultant contractor provides a one-time deliverable and may occur once or recur sporadically over time. The engagement ends upon completion of the final deliverable. The consultant contractor controls the method and manner in which the service is delivered within a statement of work (which is a detailed description of the services, goods or other deliverables that the consultant contractor is providing to the engaging enterprise).

An outsourced services contractor refers to a worker or workers engaged through a contractual agreement that provides and delivers products and/or services directly to the enterprise. The engagement ends when the contract end date is reached. The outsourced services contractor controls the method and manner in which the product or service is delivered, while the enterprise manages the supplier to specific performance factors as outlined in a service level agreement and a defined statement of work.

Although examples of labor types are provided above, note that techniques according to other examples can be used with other labor types. Also, although brief explanations are provided above for each of the foregoing example labor types, in different contexts the foregoing labor types can have different meanings.

An issue faced by enterprises is mis-classification of contingent labor type when engaging personnel. Mis-classifying contingent labor types can result in fines, penalties, and/or lawsuits against the enterprise. In the ensuing discussion, reference is made to classifying/mis-classifying or determining a labor type-note that such reference is to classifying/mis-classifying or determining a contingent labor type. In accordance with some implementations, to mitigate risks associated with classifying personnel engaged by an enterprise, techniques or mechanisms are provided to perform risk assessment associated with classification of labor types of the personnel engaged. Additionally, techniques or mechanisms according to some implementations can provide information to educate engagement managers (persons at an enterprise responsible for engaging personnel) in selecting labor types. In addition, if the risk assessment indicates that a risk level is excessive, then actions can be performed to assist engagement managers in determining an appropriate labor type to mitigate risk or determining ways of engaging the resource to reduce risk.

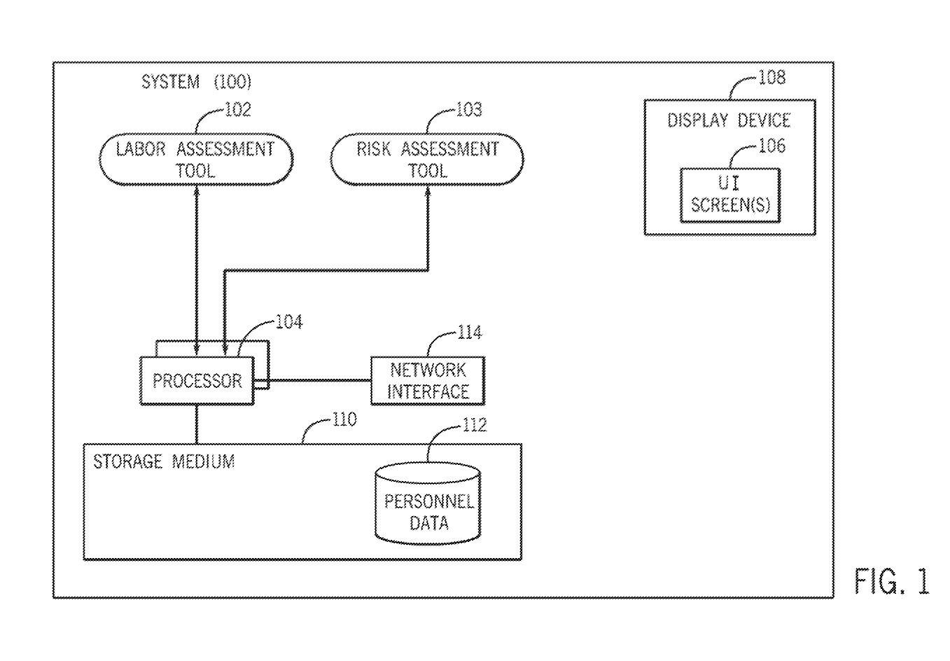

FIG. 1 shows an example system 100 that includes a labor assessment tool 102 and a risk assessment tool 103 according to some implementations. Although examples according to FIG. 1 depict two tools 102 and 103, it is noted that the tasks of these tools can be integrated into a single tool. Alternatively, the tasks of the tools 102 and 103 can be allocated to more than two tools in other examples.

The labor assessment tool 102 and risk assessment tool 103 are executable on one or multiple processors 104 of the system 100. In some examples, the labor assessment tool 102 performs some combination of the following tasks: presentation of user interface screens 106 (e.g. graphical user interface screens) on a display device 108 to prompt a user to enter information regarding personnel; presentation of information to educate a user on classification of labor types; communication with support personnel of the enterprise to assist a user of the labor assessment tool 102 in classifying labor types; classifying labor types of personnel engaged (or to be engaged) by an enterprise in response to user-entered information; and so forth.

The risk assessment tool 103 can be invoked by the labor assessment tool 102 to perform a risk assessment (by assigning a risk score or level or some other measure of risk, for example) regarding classification of a labor type for personnel engaged by an enterprise. The determination of a risk score or level associated with classification of a labor type for personnel can be based on various input parameters, which can be input by a user and/or collected from another source.

The system 100 has a storage medium 110 to store various information, including personnel data 112 that may have been entered by users (e.g. engagement managers of an enterprise). In addition, the system 100 includes a network interface 114 to allow the system 100 to communicate over a network (e.g. local area network, public network, etc.).

The system 100 can be a client computer belonging to a user. Alternatively, the system 100 can be a server computer on which the labor assessment tool 102 and risk assessment tool 103 are executed, where the server computer is able to communicate over a network with a client computer to allow the client computer to access features of the labor assessment tool 102 and risk assessment tool 103. In implementations where the system 100 is a server computer accessed by a client computer, the user interface screen(s) 106 presented by the labor assessment tool 102 may be presented on a display device of the client computer.

The user interface screen(s) 106 can also be used to present output information from the labor assessment tool 102 and the risk assessment tool 103, including classifications of labor types, results of risk assessment, educational information to assist users, and so forth.

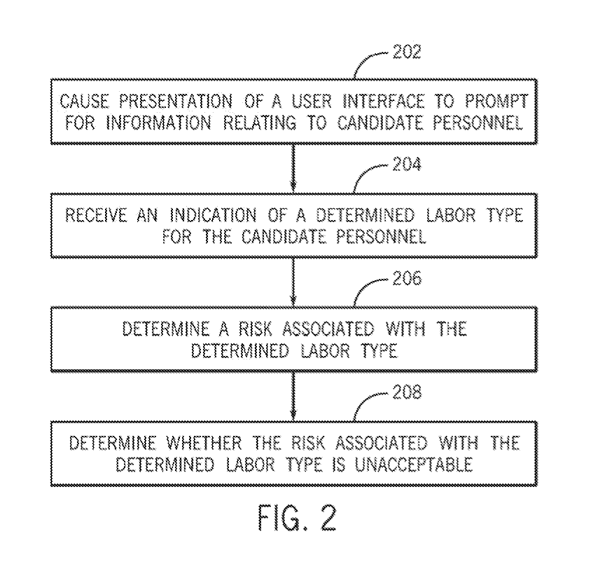

FIG. 2 is a flow diagram of a process performed by the labor assessment tool 102, according to some implementations. The labor assessment tool 102 causes (at 202) presentation of a user interface (e.g. a user interface screen 106 of FIG. 1) to prompt for information relating to candidate personnel to be engaged by an enterprise. Next, the labor assessment tool 102 receives (at 204) an indication of a determined labor type for the candidate personnel. The determined labor type can be a labor type classified by the user of the labor assessment tool 102. Alternatively, the determined labor type can be automatically classified by the labor assessment tool 102, based on other information entered by the user relating to the candidate personnel.

The labor assessment tool 102 determines (at 206) a risk associated with the determined labor type for the candidate personnel. This determination (206) can be performed by the labor assessment tool 102 invoking the risk assessment tool 103, and the risk assessment tool 130 returning a risk assessment (e.g. risk score or risk level) to the risk assessment tool 102.

The labor assessment tool 102 next determines (at 208) whether the risk associated with the determined labor type is unacceptable. If the risk is determined to be acceptable, then the determined labor type can be accepted for classifying the candidate personnel. However, if the risk is determined to be unacceptable, then steps can be taken to perform risk mitigation, including providing educational information to the user of the labor assessment tool 102 regarding proper classification of labor type, as well as forwarding of information pertaining to the candidate personnel to a support group to assist the user in performing labor type classification for the candidate personnel.

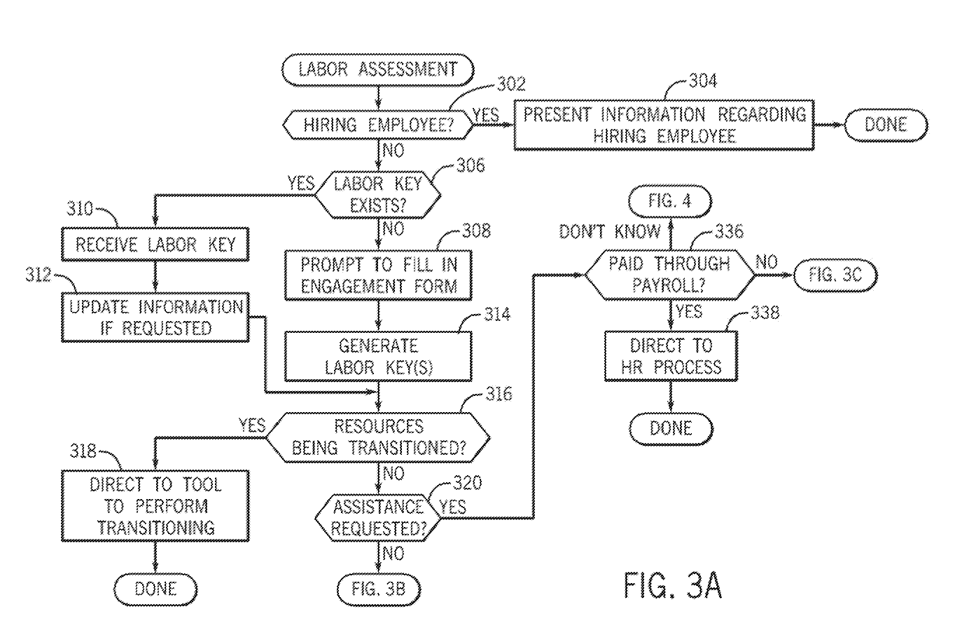

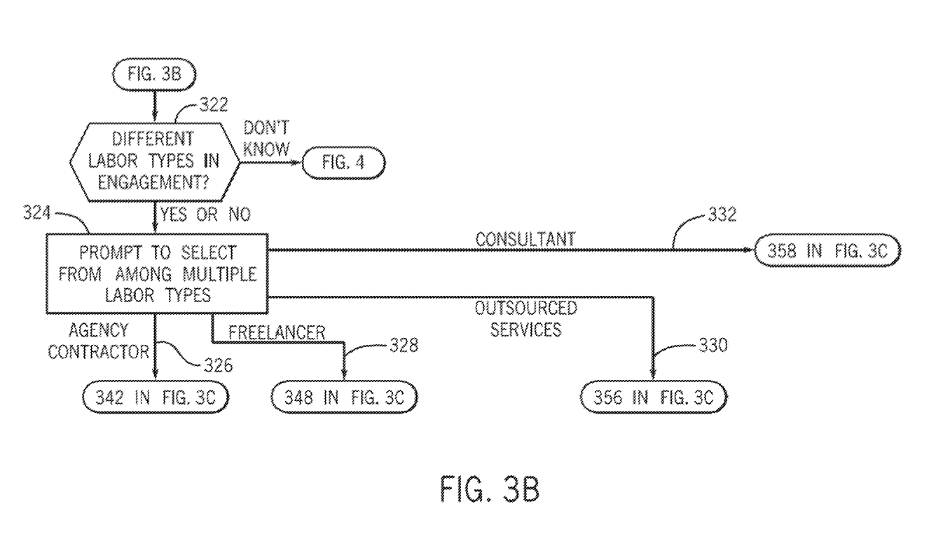

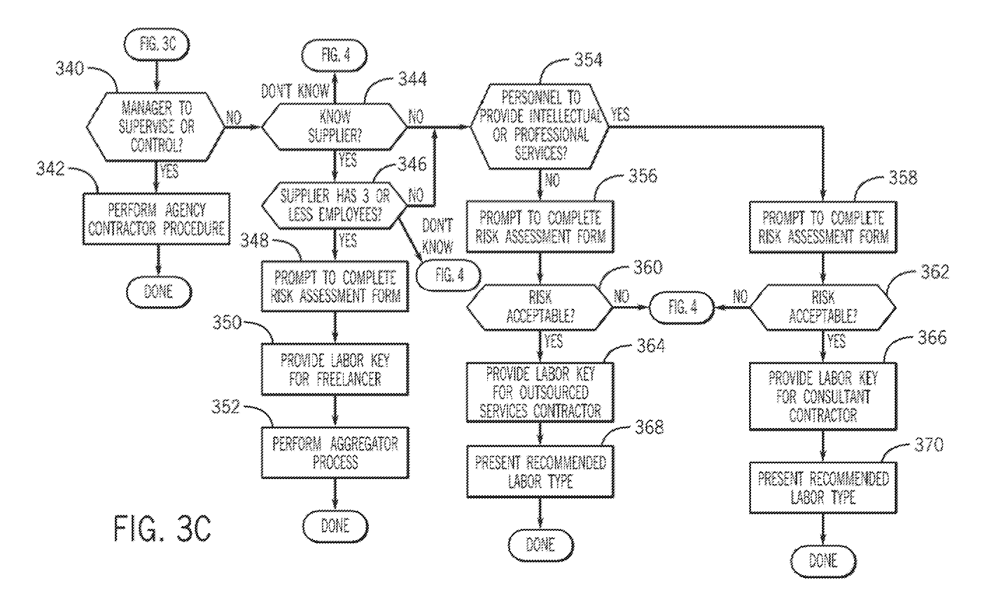

FIGS. 3A-3C depict a flow diagram of a process of the labor assessment tool 102 according to further implementations. Although various example tasks are depicted in FIGS. 3A-3C, note that in alternative implementations, the labor assessment tool 102 can perform additional or different tasks.

The labor assessment tool 102 determines (at 302) if candidate personnel being hired by an engagement manager is an employee. If so, then information is presented (at 304) indicating the appropriate links and resources that are to be followed for hiring an employee, at which point the process of the labor assessment tool 102 is done.

If it is determined that the engagement manager is not hiring an employee, then the labor assessment tool checks (at 306) whether a labor key exists. A labor key is associated with a particular engagement, and indicates a labor type for personnel that is part of an engagement. An “engagement” refers to an arrangement to engage services of one or multiple personnel, which can be according to a specific labor type or according to multiple labor types. An engagement can be part of a “record.” which can include information pertaining to the engagement. If multiple labor types are associated with the engagement, then multiple labor keys can be part of the record. A labor key is used to identify a specific labor type in the engagement, and the labor key is associated with information pertaining to personnel of the respective labor type.

The determination at 306 of whether a labor key exists is a determination of whether the engagement manager is returning to the labor assessment tool 102 to continue with classifying a labor type after having previously exited the labor assessment tool 102. If no labor key exists for a particular engagement, then the labor assessment tool 102 prompts (at 308) the engagement manager to fill in general information relating to the engagement in a predefined engagement form. Examples of the general information that can be entered into the engagement form can include any combination of the following: the name of the requestor (engagement manager), the email address of the requestor, region where work is to be completed, a business unit associated with the enterprise, a project identifier, a project description, client type (e.g. internal client or external client), business partner name (name of a global procurement representative in the global procurement department of the enterprise), a category contact name (name of a category manager that is part of the global procurement department), and so forth. The global procurement department of an enterprise is responsible for procuring services from outside suppliers on behalf of the enterprise. A category manager is a manager responsible for a particular division or category of the enterprise.

If the labor assessment tool 102 determines (at 306) that a labor key already exists, the labor assessment tool 102 receives (at 310) the labor key after prompting the engagement manager to enter the labor key. If requested by the engagement manager, information of the labor key can be updated (at 312). The process then proceeds to task 316.

After information has been entered in the engagement form (at 308), a labor key (or labor keys) can be generated (at 314) if the labor key(s) did not previously exist. Note that a labor key is generated for each labor type.

Next, the labor assessment tool 102 asks (at 316) if any resource of the engagement is being transitioned. Transitioning a resource refers to changing personnel from one labor type to another labor type. If transitioning of resources is being performed, then the labor assessment tool 102 directs (at 318) the engagement manager to another tool to assist the engagement manager in performing the transition of resources.

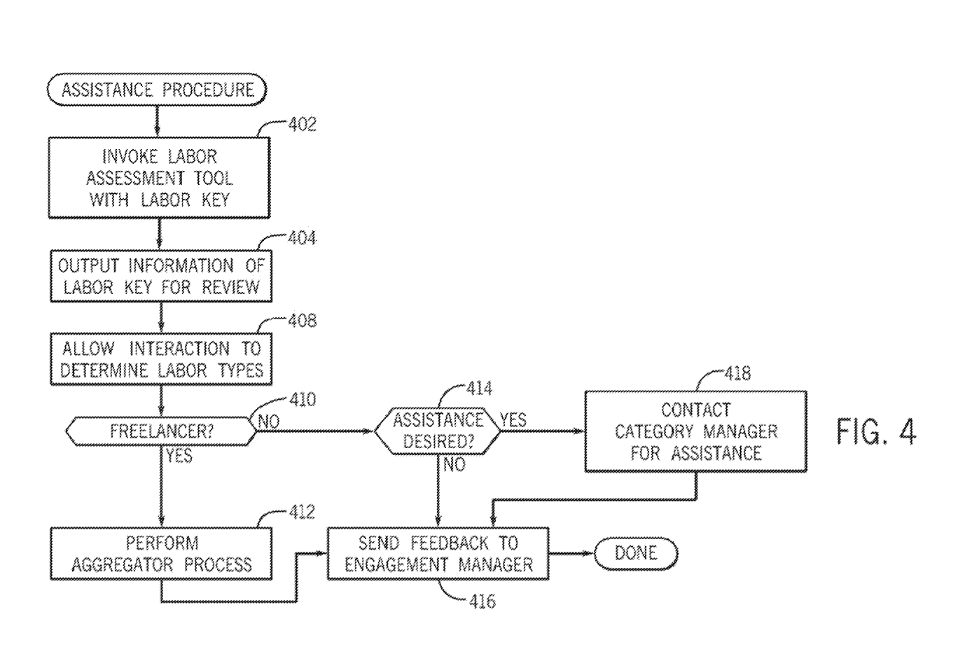

However, if a transitioning of resources is not being performed, the labor assessment tool 102 asks (at 320) the engagement manager if assistance is requested for classifying personnel for the engagement. If the engagement manager indicates that assistance is not being requested, as further shown in FIG. 38, then the labor assessment tool 102 asks (at 322) if there are different labor types in the engagement. If the engagement manager indicates that the engagement manager is unsure (the answer is “don't know”), then the labor assessment tool 102 invokes an assistance procedure (FIG. 4) to assist the engagement manager. However, if the engagement manager answers either yes or no to the question posed at 322, then the engagement manager is prompted (at 324) to select a labor type from multiple labor types (e.g. freelancer, agency contractor, outsourced services contractor, or consultant contractor).

If the labor assessment tool 102 determines that the selected labor type is an agency contractor (326), then an agency contractor procedure is performed (task 342 in FIG. 3C, discussed further below). However, if the risk assessment tool 102 determines that the selected labor type is a freelancer (328), then a freelancer procedure is performed (starting at task 348 in FIG. 3C, discussed further below). Alternatively, if the risk assessment tool 102 determines that the selected labor type is an outsourced services contractor (330), then a outsourced services contractor procedure is performed (starting at task 356 in FIG. 3C). On the other hand, if the selected labor type is the consultant contractor (332), then a consultant contractor procedure is performed (starting at task 358 in FIG. 3C).

At task 320 in FIG. 3A, if the engagement manager indicates that the assistance is requested in performing classification of personnel, then the labor assessment tool 102 asks (at 336) whether the personnel is to be paid through the enterprise's payroll system. If the engagement manager is unsure (“don't know), then an assistance procedure according to FIG. 4 is performed. If the engagement manager answers in the affirmative (that the personnel is to be paid through the enterprise's payroll system), then the labor assessment tool 102 directs (at 338) the engagement manager to resources and a process for hiring employees.

However, if the engagement manager indicates that the personnel is not to be paid through the enterprise's payroll system, then the labor assessment tool 102 asks (at 340 in FIG. 3C) whether a manager of the enterprise would supervise or control any personnel or supervise or manage the specific manner in which the personnel performs work. If an affirmative answer is received, then the labor assessment tool concludes that the personnel falls into the agency contractor category, and an agency contractor procedure is performed (at 342). The agency contractor procedure includes determining whether the agency contractor labor type is allowed (such as according to an enterprise policy regarding whether use of an agency contractor is allowed for a particular engagement), and whether the engagement is planned to complete within a time frame according to a policy of the enterprise. In response to an affirmative response to both the foregoing questions, the agency contractor procedure 342 generates a labor key for an agency contractor, and presents a response given regarding the recommended labor type.

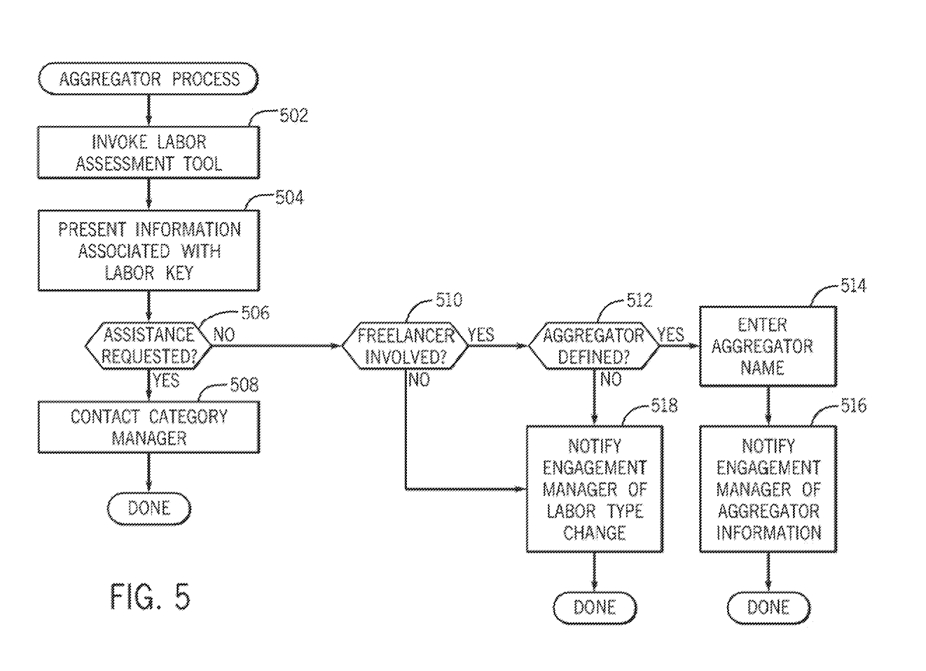

However, if, at 340, the engagement manager answers in the negative, then the labor assessment tool 102 asks (at 344) whether the engagement manager knows the supplier of the personnel that the engagement manager is to work with. If the engagement manager is unsure (“don't know”), then tasks 414-418 of the FIG. 4 assistance procedure is followed. However, if the engagement manager indicates that the engagement manager does know the supplier, the labor assessment tool 102 asks (at 346) whether the supplier has three (or some other predefined number set by enterprise policy or industry benchmark) or less employees. If the answer is “don't know,” then the FIG. 4 assistance procedure is followed. If the supplier has three or less employees, then the labor assessment tool 102 concludes that the personnel falls into the freelancer category, and prompts (at 348) the engagement manager to complete a risk assessment form. Filling in the risk assessment form allows the labor assessment tool 102 to produce a risk score that can be used for determining whether the risk associated with classification of personnel according to labor type is acceptable or unacceptable. Next, a labor key for the freelancer engagement is provided (at 350). An aggregator process is then performed (at 352) (FIG. 5).

However, if the engagement manager indicates (at 344) that the engagement manager does not know the supplier, or if the engagement manager indicates that the supplier has more than three employees (at 346), then the labor assessment tool 102 asks (at 354) whether the personnel is to provide intellectual or professional services that are advisory in nature. If the answer is no, then the labor assessment tool 102 concludes that the personnel falls into the outsourced services contractor category. On the other hand, if the answer is yes, then the labor assessment tool 102 concludes that the personnel falls into the consultant contractor category.

As shown in FIG. 3C, from either the yes or no branch, the engagement manager is prompted to complete the risk assessment form (356 or 358), which causes a respective risk score to be produced. From the risk score, the labor assessment tool 102 determines (at 360 or 362) whether the risk is acceptable. If not, then the FIG. 4 procedure is followed. If the risk is acceptable in either case, the respective labor key is provided (364 or 366) for the outsourced services contractor or consultant contractor, respectively. The recommended labor type is then presented (at 366 or 368). Further processes are then performed.

FIG. 4 is an assistance procedure performed using the labor assessment tool 102 to assist the engagement manager under certain conditions (as indicated in FIG. 3A-3C). Although various example tasks are depicted in FIG. 4, note that in alternative implementations, the assistance procedure can perform additional or different tasks. The procedure of FIG. 4 is performed using the labor assessment tool 102 by the representative of a global procurement department of the enterprise, who has expertise in assessing labor types for personnel. The global procurement department is an example of a group that can be consulted for a situation where a determined labor type is deemed to be high risk—in other examples, other predefined groups in the enterprise can be consulted to assist in such situation. The labor assessment tool 102 is invoked (at 402) by the global procurement representative with a labor key that was received with a request invoking the assistance procedure. The labor assessment tool 102 outputs (at 404) information associated with the labor key for review by the global procurement representative.

Next, the labor assessment tool 102 allows (at 408) interaction between the global procurement representative and the engagement manager to determine the labor type(s) associated with the engagement. For example, the labor assessment tool 102 can present user interface screens to the global procurement representative and engagement manager to allow communication between the global procurement representative and the engagement manager. The labor assessment tool 102 then determines (at 410) if there is freelancer involvement. If so, then the aggregator process is performed (at 412), which is described in connection with FIG. 5 (discussed further below). After performing the aggregator process, feedback is sent (at 416) to the engagement manager regarding the classified labor type(s).

If there is no freelancer involvement (as determined at 410), then the labor assessment tool 102 determines (at 414) if additional assistance is desired to provide a recommendation to the engagement manager (such determination can be based on input from the global procurement representative, for example, at the labor assessment tool 102). If not, then the labor assessment tool 102 sends (at 416) feedback to the engagement manager regarding the classified labor type(s) for the engagement.

If additional assistance is requested, then the labor assessment tool 102 can be used by the general procurement representative to contact (at 418) a category manager to request assistance in classifying labor types for the engagement. The category manager is part of the global procurement department and has specific expertise in a particular division or category. Although reference is made to “category manager” herein, it is noted that in other examples, other experts with knowledge of labor engagements and labor classifications can be consulted. Feedback is then sent (at 416) to the engagement manager regarding the classified labor type(s).

The feedback provided (at 416) enables the engagement manager to re-enter the labor assessment tool 102 with the correct labor classification. In this manner, the engagement manager is able to proceed through tasks 306, 310 and 312 shown in FIG. 3A, which is part of a fast-track procedure when the engagement manager knows the correct classification of the labor type.

FIG. 5 is the flow diagram of an aggregator process that is performed in response to detection of involvement of a freelancer. The aggregator process of FIG. 5 can be invoked from either the process of FIGS. 3A-3C or the process of. 4, as discussed above. Although various example tasks are depicted in FIG. 5, note that in alternative implementations, the aggregator process can perform additional or different tasks.

The process of FIG. 5 is performed by the labor assessment tool 102. The labor assessment tool 102 is invoked (at 502) using a labor key received with the invocation of the aggregator process. The labor assessment tool 102 can be invoked by a user, such as the engagement manager or a global procurement representative, for example. Next, the labor assessment tool 102 presents (at 504) information associated with the labor key, for viewing by the user.

Next, it is determined (at 506) if assistance is requested by the user. If assistance is requested, then a category manager is contacted (at 508) for assistance. If assistance is not requested, then it is determined (at 510) whether the engagement involves a freelancer. If so, the labor assessment tool 102 determines (at 512) if an aggregator has been defined for this engagement. An “aggregator” refers to an entity that acts as an employer to freelancers working on temporary assignments. When using freelancers to fill temporary positions, an enterprise may contract with an aggregator to provide the freelancers.

If an aggregator has been defined, then the name of the aggregator is entered (at 514) using the respective labor key for the freelancer labor type. The engagement manager is then notified (at 516) of the aggregator. At this point, the engagement manage can draft a statement of work (SOW) for the freelancer, and information relating to the SOW can then be sent to the aggregator. The SOW communicated to the aggregator contains details of the engagement of a service to cause the aggregator to engage the candidate personnel on behalf of the enterprise.

The aggregator can then contact the candidate personnel to determine whether the candidate personnel is willing to be engaged as a freelancer by the aggregator. If not, then the aggregator sends an indication to the enterprise indicating that the candidate personnel is unwilling to be engaged as a freelancer. In response to such indication, the enterprise can change the labor type of the candidate personnel from freelancer to another labor type.

If the determination at 512 indicates that there is no aggregator defined for the engagement, or if the determination at 510 indicates that there is no freelancer involvement, then an appropriate labor type recommendation (different from the freelancer labor type) is provided (at 518) to the engagement manager using the labor assessment tool 102. The engagement manager receives notification of the labor type change, and the engagement manager determines whether the labor type change is acceptable. If not, then a process to handle the unacceptable labor type change is performed. On the other hand, if the labor type change is deemed acceptable by the engagement manager, then the labor assessment tool 102 follows the process for the labor type that has been recommended. The engagement manager or a global procurement representative can update the labor assessment tool 102 with the appropriate labor type.

As discussed above in connection with FIGS. 3A-3C, the labor assessment tool 102 can prompt the engagement manager to enter information into a risk assessment form (e.g. tasks 328, 348, 356, and 358). Information entered into the risk assessment form can be processed by the risk assessment tool 103 (FIG. 1) to generate a measure of risk (e.g. risk score or risk level). The risk score can be a numeric score, whereas the risk level can be one of several discrete levels corresponding to respective different risks.

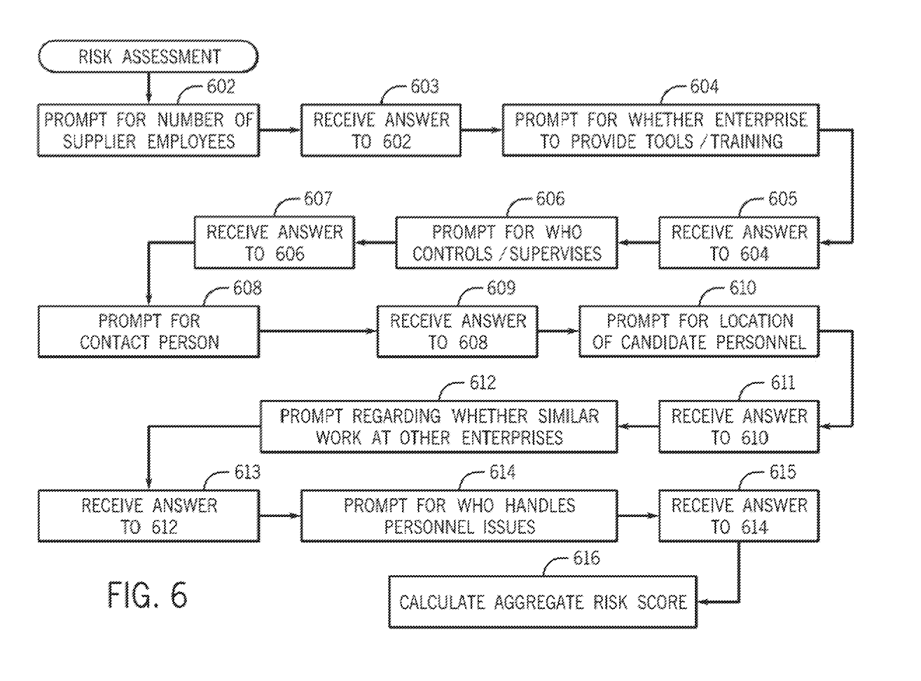

The risk assessment form into which the engagement manager is prompted to enter information can request the engagement manager to enter any combination of the following information. As shown in FIG. 6, a process performed by the risk assessment tool 103 prompts an engagement manager for various information, and computes a risk score based on the answers. The risk assessment form presented by the risk assessment tool 103 prompts (at 602) entry of information regarding a number of employees of a supplier, such as whether a supplier has greater than three (or some other predefined number of) employees. The risk assessment tool 103 receives (at 603) an answer to the prompt (602). A smaller number of employees is associated with a higher risk score, while a larger number of employees is associated with smaller risk score. To reduce the risk that personnel of a small supplier may be considered an employee of the enterprise, risk mitigation information is provided to the engagement manager that the engagement manager should manage the personnel's work by deliverables and not provide direct management of the work.

The risk assessment form also prompts (at 604) for information regarding whether the enterprise is to provide any tools or training to the personnel to be engaged. The risk assessment tool 103 receives (at 605) an answer to the prompt (604). If the answer is yes, then a higher risk score is assessed; however, if the answer is no (no training or tool us provided to the personnel), then a lower risk score is assigned. Providing general industry skills training increases risk that the personnel may be considered an employee.

The risk assessment form also prompts (at 606) for information regarding who controls the manner in which the work is performed and who supervises the performance of the work. The risk assessment tool 103 receives (at 607) an answer to the prompt (606). The choices can include the following: the enterprise, an agency contractor, a supplier, or some combination of the following. The enterprise being involved in determining the manner in which the work is performed and in supervising the performance of the work increases the risk that the personnel may be classified as an employee, and thus a higher risk score is assigned. If it is determined that the enterprise has to direct the work of the engagement, then the engagement manager is provided with help information to reconsider whether the personnel should be considered an employee or an agency contractor.

The risk assessment form also prompts (at 608) for information regarding who the personnel to be engaged should contact if problems or complaints arise during the engagement, and who is responsible for the resolution of the problems or complaints. The risk assessment tool 103 receives (at 609) an answer to the prompt (608). A higher risk score is assigned if the enterprise is to be contacted, while a lower risk score is assigned if an outside supplier is the one to be contacted for issue resolution.

The risk assessment form also prompts (at 610) for information regarding where the personnel to be engaged is to be located during the engagement. The risk assessment tool 103 receives (at 611) an answer to the prompt (610). A higher risk score is assigned if the personnel is to be located at the site of the enterprise, while a lower risk score is assigned if the personnel is to be located at the site of an outside supplier. An intermediate risk score is assigned if the personnel is to be located at both the enterprise site and the supplier site.

The risk assessment form also prompts (at 612) for information regarding whether the personnel to be engaged provides similar work for other enterprises during the same time period as for the subject enterprise. The risk assessment tool 103 receives (at 613) an answer to the prompt (612). If the answer is yes, then a lower risk score is assigned; on the other hand, if the answer is no, then a higher risk score is assigned.

The risk assessment form also prompts (at 614) for information regarding who handles personnel issues including work assignment, performance management, termination, discipline, and pay of the personnel to be engaged. The risk assessment tool 103 receives (at 615) an answer to the prompt (614). If the enterprise is involved, then a higher risk score is assigned, while if the external supplier is involved, then a lower risk score is assigned.

Based on the answers received (603, 605, 607, 609, 611, 613, 615) to the questionnaires posed in the risk assessment form as listed above, the risk assessment tool 103 can calculate (at 616) the aggregate risk score, which is then provided to the labor assessment tool 102 for determining whether the risk is acceptable or unacceptable. Whether the risk is acceptable or not is based on a comparison of the aggregate risk score to a predefined threshold. If the risk score exceeds (greater than or less than depending upon whether a higher score indicates greater or less risk) the predefined threshold, then the risk is indicated as unacceptable. In some implementations, the predefined threshold can be uniform across different contingent labor types—in other implementations, different thresholds can be specified for at least some of the contingent labor types.

An individual score can be assigned to each of the answers received at 603, 605, 607, 609, 611, 613, and 615. For example, if the answer at 603 indicates that the supplier has greater than 3 employees, then an individual numeric score of zero can be assigned. If the answer at 603 indicates that the supplier has 2 or 3 employees, then an individual numeric score of 10 can be assigned. If the answer at 603 indicates that the supplier has 1 employee, then an individual numeric score of 20 can be assigned (a higher numeric score indicates higher risk). Similarly, individual numeric scores can be assigned to each of the other answers given at 605, 607, 609, 611, 613, and 615. These individual numeric scores can then be aggregated (e.g. summed) to produce an aggregate risk score. Alternatively, weights can be assigned to each of the incividual numeric scores, such that a weighted sum is produced as the aggregate risk score.

Although various example types of information are listed above as being sought by the risk assessment form, note that in other implementations, other types of information can be sought by the risk assessment form to be processed by the risk assessment tool 103 to generate a respective risk measure. For example, such other types of information can be according to tax regulations set by the respective government taxing agency. Alternative types of information can also be sought for determining risk assessment, based on specific applications of enterprises.

The labor assessment tool 102 and risk assessment tool 103 according to some implementations allows for relatively convenient and quick feedback regarding a risk associated with classifying a labor type for candidate personnel to be engaged by an enterprise. If the risk is indicated to be too high, then assistance can be provided to help in properly classifying the labor type. The ability to identify risks associated with classified labor types can help reduce the exposure of an enterprise to issues associated with mis-classifying personnel.

The labor assessment tool 102 and risk assessment tool 103 of FIG. 1 can be implemented as machine-readable instructions that can be loaded for execution on a processor or multiple processors (such as 104 in FIG. 1). A processor can include a microprocessor, microcontroller, processor module or subsystem, programmable integrated circuit, programmable gate array, or another control or computing device.

Data and instructions are stored in respective storage devices, which are implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
causing, by a system having a processor, presentation of a user interface prompting for information relating to candidate personnel to be engaged by an enterprise;
determining, by the system, a risk associated with a determined labor type for the candidate personnel; and
determining, by the system, whether the risk associated with the determined labor type is unacceptable.

2. The method of claim 1, further comprising:
in response to determining that the risk associated with the labor type is unacceptable, providing a prompt that a predefined group of the enterprise is to be contacted for assistance.

3. The method of claim 1, wherein the determined labor type is selected from among a freelancer, an agency contractor, an outsourced services contractor, and a consultant contractor.

4. The method of claim 1, further comprising receiving an indication of the determined labor type based on input from a user.

5. The method of claim 1, further comprising receiving an indication of the determined labor type based on automated selection by the system according to the information received through the user interface.

6. The method of claim 1, wherein determining the risk associated with the determined labor type is based on a combination of one or multiple of the following: number of employees of a supplier of the candidate personnel, amount of training and/or tools to be provided by the enterprise to the personnel, level of supervision of the candidate personnel, contact person for issues encountered by the candidate personnel while engaged by the enterprise, location of the candidate personnel while doing work for the enterprise, whether the candidate personnel provides similar services to other enterprises, and whether the enterprise is responsible for personnel issues associated with the candidate personnel.

7. The method of claim 1, further comprising:
in response to detecting that the determined labor type for the candidate personnel is a freelancer, identifying an aggregator for the freelancer.

8. The method of claim 7, further comprising communicating details of engagement of the candidate personnel to the aggregator to cause the aggregator to engage the candidate personnel on behalf of the enterprise.

9. The method of claim 8, further comprising:
receiving, from the aggregator, an indication that the candidate personnel is unwilling to be engaged as a freelancer;
in response to the indication, changing a labor type for the candidate personnel.

10. An article comprising at least one machine-readable storage medium storing instructions that upon execution cause a system to:
receive information relating to candidate personnel to be engaged by an enterprise;
determine a labor type from among plural different labor types for the candidate personnel;
calculate a risk score for the determined labor type; and
determine, based on the risk score, whether a risk associated with the determined labor type is unacceptable.

11. A system comprising:
at least one processor to:
receive information relating to candidate personnel to be engaged by an enterprise;
receive a classification of a labor type of the candidate personnel;
determine a risk associated with the classification of the labor type; and
perform an action according to the determined risk.

12. The system of claim 11, wherein the at least one processor is to further:
receive information entered into a risk assessment form; and
calculate a measure of risk based on the information in the risk assessment form, wherein the risk associated with the classification is determined based on the measure of risk.

13. The system of claim 11, wherein the at least one processor is to further:
direct a user to assistance in response to determining that the risk is unacceptable.

14. The system of claim 11, wherein the at least one processor is to further:
in response to determining that the risk is acceptable,
present the labor type to a user; and
generate a labor key for the labor type, wherein the labor key is useable to access information associated with the labor type.

15. The system of claim 11, wherein the classification of the labor type is user-entered or automatically generated.
